(19) United States
(12) Patent Application Publication
(10) Pub. No.: US 2007/0278276 A1
(43) Pub. Date: Dec. 6, 2007

(54) Nailing Tool with Displacable Discharge Tube

(76) Inventor: Wan-Fu Wen, Taipei Hsien (TW)

Correspondence Address: Wen-Chin Hu, 4331 Stevens Battle Lane, Fairfax, VA, 22033, US

(21) Appl. No.: 11/422,323

(22) Filed: Jun. 5, 2006

(51) Int. Cl. B25C 1/04

(52) U.S. Cl. 227/130

(57) ABSTRACT

A nailing tool with a displaceable discharge tube includes a palm nailer, a first guiding sleeve fixed to the palm nailer, a second guiding sleeve, and a displaceable discharge tube. The first guiding sleeve includes a spring, and the second guiding sleeve moveably engaged in the first guiding sleeve. The spring abuts against the second guiding sleeve and causes it outwardly elongate or inwardly retracts relative to the first guiding sleeve. The second guiding sleeve defines a joint member disposed at a bottom portion thereof for engaging with a discharge tube accommodating a single nail or a discharge tube of a magazine. With this configuration, the nailing tool can conveniently select the driving mode of striking a single nail or continuously striking nails.

### BACKGROUND

The present invention relates to a palm nailer, and more particularly to a nailing tool, which is able to select to engage with a discharge tube containing a single nail or a discharge tube of a magazine for continuously providing nails.

Typical palm nailer is a kind of hand-hold pneumatic driving tool. Previous palm nailer is used for replacing conventional hammer to strike nails into work piece, which includes a discharge tube for containing a single nail. In operation, a high pressure induce piston of the palm nailer causes the driving shaft connected thereto to press down and strike the nail to driving it into the work piece.

Unlike the above-described palm nailer, there is another kind of pneumatic driving tool, which is so-called nail gun. Generally, the nail gun includes a magazine connecting with a discharge tube thereof. The magazine contains a plurality of aligned nails therein, which may be continuously pushed into the discharge tube one by one. The driving shaft of the nail gun may strike the nails into work piece in turn.

In addition, U.S. Pat. No. 6,443,348 disclosed a palm nailer employing a magazine, and the palm nailer is able to continuously strike nails into work piece. In which, the magazine connects with a side of the discharge tube of the palm nailer for pushing the nails from the magazine into the discharge tube one by one. Then, the driving shaft thereof may strike the nails in turn.

However, even the palm nailer employs a magazine, and the magazine enables the palm nailer continuously drive nails, there are still differences in the thickness between the various work pieces to be nailed. That is, it needs different kinds of nails to nail various work pieces in different thickness. But the magazine is fixed to the palm nailer, and is hard to disassemble. With this configuration, it requests the user to equip several kinds of palm nailers for driving different kinds of nails, it bring unduly burdensome.

Accordingly, what is needed is a nailing tool that can overcome the above-described deficiencies.

### BRIEF SUMMARY

The present invention is to provide a nailing tool with a displaceable discharge tube, which can select to engage with a discharge tube containing a single nail or a discharge tube of a magazine for continuously providing nails, so as to improve the efficiency of nails driving.

For achieving the object, the nailing tool according to the present invention includes a palm nailer, a first guiding sleeve fixed to the palm nailer, a second guiding sleeve, and a displaceable discharge tube. The palm nailer includes a pneumatic driving shaft therein. The first guiding sleeve includes a compressed spring nesting the driving shaft, and the second guiding sleeve is moveably engaged in the first guiding sleeve. The spring abuts against the second guiding sleeve and causes it outwardly elongate or inwardly retract relative to the first guiding sleeve, and guides the driving shaft to strike nails. The second guiding sleeve defines a joint member disposed at a bottom portion thereof for connecting with different discharge tubes.

The joint member can engage with a discharge tube accommodating a single nail or a discharge tube of a magazine which is able to continuously provide nails. With this configuration, various discharge tubes can engage with or disassemble from the joint member, which make the nailing tool conveniently select the mode for driving nails.

Other advantages and novel features will become more apparent from the following detailed description when taken in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, side cross-sectional view of part of a nailing tool according to an embodiment of the present invention, showing a first guiding sleeve and a second guiding sleeve;

FIG. 2 is a schematic, side cross-sectional view of the nailing tool, showing a discharge tube accommodating a single nail engaging with the second guiding sleeve;

FIG. 2a is a schematic, cross-sectional view taken along line 2a-2a of FIG. 2, showing the second guiding sleeve, the discharge tube, and a driving shaft of the nailing tool having a circular cross section;

FIG. 3 is a schematic, side cross-sectional view of the nailing tool of FIG. 2, shown when a single nail contained in the discharge tube is being driven into a work piece;

FIG. 4 is a schematic, side cross-sectional view of a nailing tool according to another embodiment of the present invention, showing a discharge tube with a sideward passage engaging with the second guiding sleeve;

FIG. 5 is a schematic, side cross-sectional view of the nailing tool of FIG. 4, showing a magazine connecting with the discharge tube via the sideward passage for continuously providing nails; and

FIG. 6 is a schematic, side cross-sectional view of the nailing tool of FIG. 5, shown when nails contained in the magazine is being driven into a work piece one by one.

### DETAILED DESCRIPTION

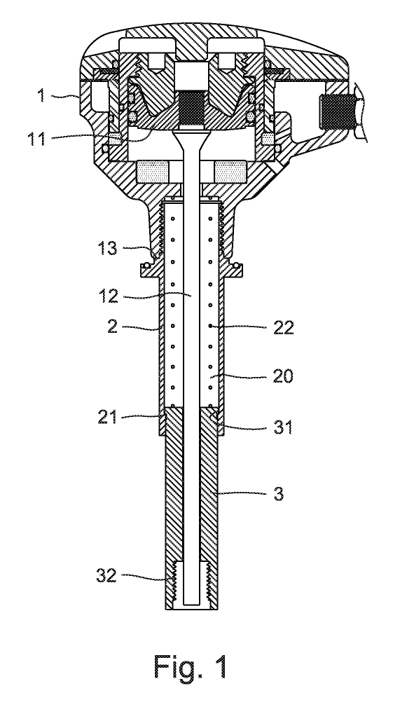

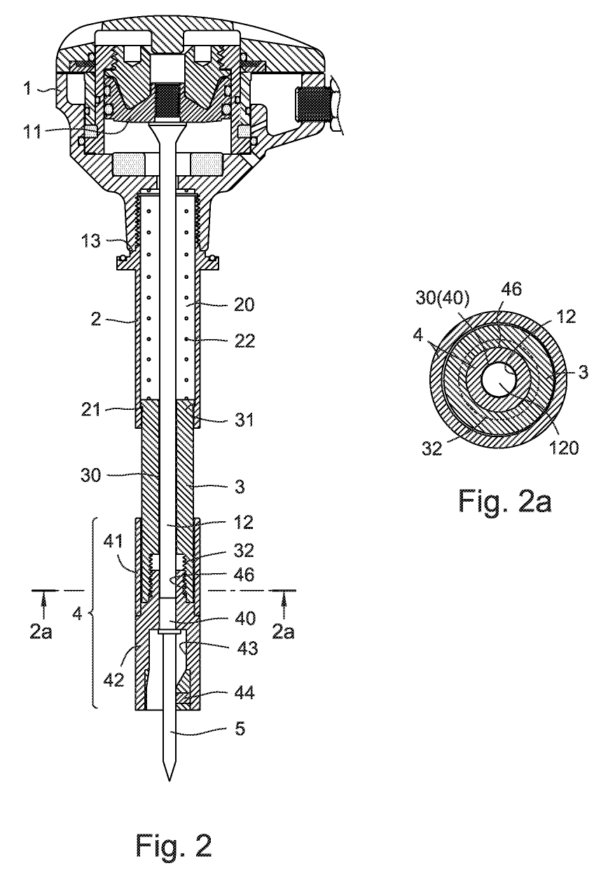

Referring to FIG. 1, a schematic, side cross-sectional view of part of a nailing tool according to an embodiment of the present invention is shown. The nailing tool includes a palm nailer 1, a first guiding sleeve 2, a second guiding sleeve 3, and a joint member 32 (shown in FIG. 2).

The palm nailer 1 includes a high pressure induce piston 11 with a plate shape, and a driving shaft 12 connecting with the piston 11. The shaft 12 is elongated out of the palm nailer 1 via a bottom opening 13 thereof.

The first guiding sleeve 2 is fixed to the bottom opening 13 of the palm nailer 1. The first guiding sleeve 2 defines a through guiding hole 20 therein, which includes at least a block 21 disposed at a distal end of the guiding hole 20. A compressed spring 22 is disposed in the through guiding hole 20. The driving shaft 12 is moveably elongated in the through guiding hole 20, and is nested by the compressed spring 22.

The second guiding sleeve 3 is moveably nested in the through guiding hole 20 of the first guiding sleeve 2, and being abutted against by the compressed spring 22. The second guiding sleeve 3 includes at least a block 31 to abut and block off the block 21 of the first guiding sleeve 2. The spring 22 and the block 21, 31 cooperatively engage with each other to make the second guiding sleeve 3 resiliently outwardly elongate or inwardly retract relative to the first guiding sleeve 2.

The joint member 32 is defined at a distal end of the second guiding sleeve 3.

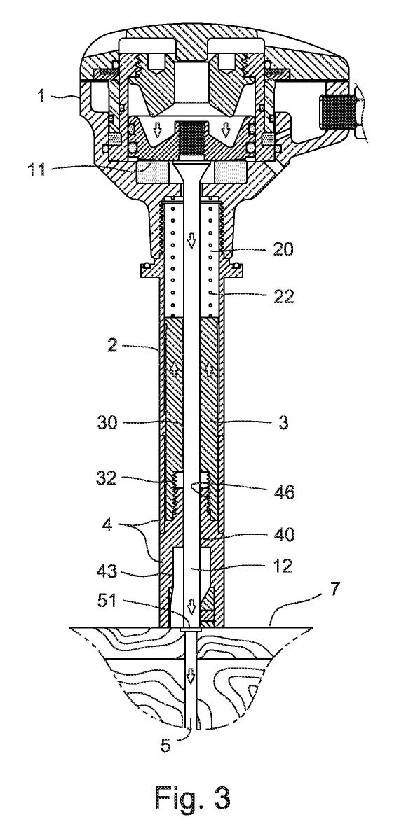

Referring to FIG. 2, a discharge tube 4 is engaged with the second guiding sleeve 3. The discharge tube 4 includes an outer sleeve 41, and a nail sleeve 42 soldered with the outer sleeve 41. The discharge tube 4 is stably connected with the joint member 32 of the second guiding sleeve 3. The discharge tube 4 further includes a chamber 43 for accommodating a single nail 5 therein. In use, the driving shaft 12 can elongate into the discharge tube 4 to strike the nail 5 into the work piece 7 (shown in FIG. 3).

Each of the second guiding sleeve 3 and the discharge tube 4 has a guiding channel 30 or 40 formed therein. The cross section of the guiding channels 30 and 40 are shaped as circular, which can steadily guide and hold the driving shaft 12 therein (shown in FIG. 2a). The body and the striking surface 120 of the driving shaft 12 have a circular cross section. As such, the circular striking surface of the driving shaft 12 can cause the driving shaft 12 evenly strike on the nail head 51 of the nail 5 (shown in FIG. 3)

Moreover, the joint member 32 defines an internal thread (not labeled) at the bottom portion of the second guiding sleeve 3, for mating with the external thread 46 of the discharge tube 4 (shown in FIG. 2). Furthermore, the position of the internal thread and the external thread 46 can be exchanged. Various modifications and alterations are possible within the ambit of the connection therebetween. For example, respectively defines a hook and a slot, or an elastic bead structure and a groove, or any other connection elements that are able to conveniently disassemble.

The above-described discharge tube 4 includes a guiding channel 40 connecting with the chamber 43, and the chamber 43 includes a magnetic element 44 for stably holding the nail 5 in the chamber 43.

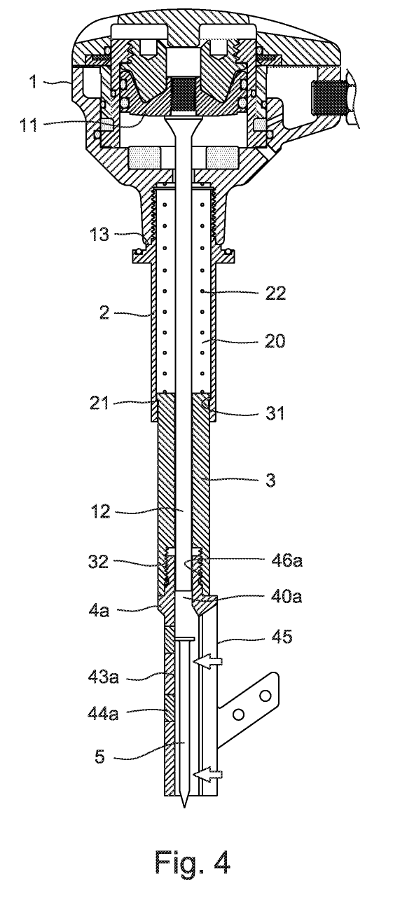

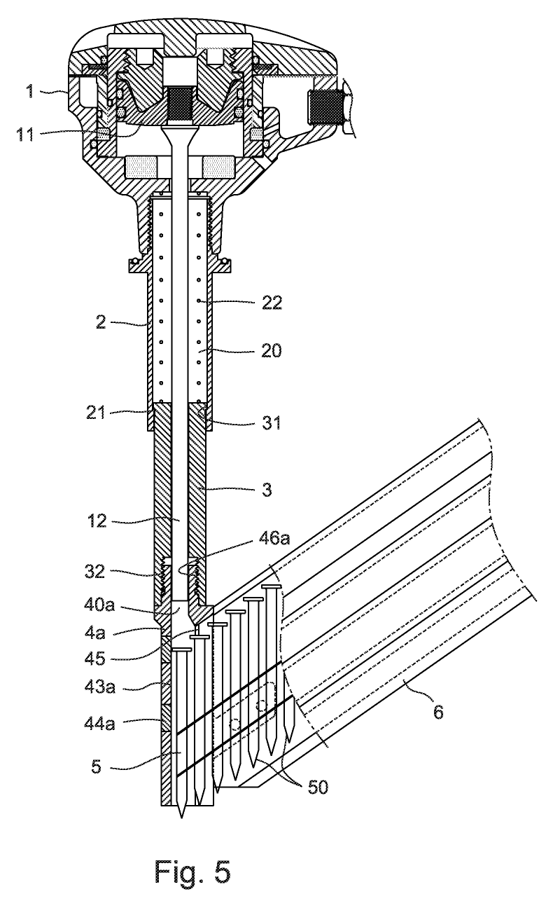

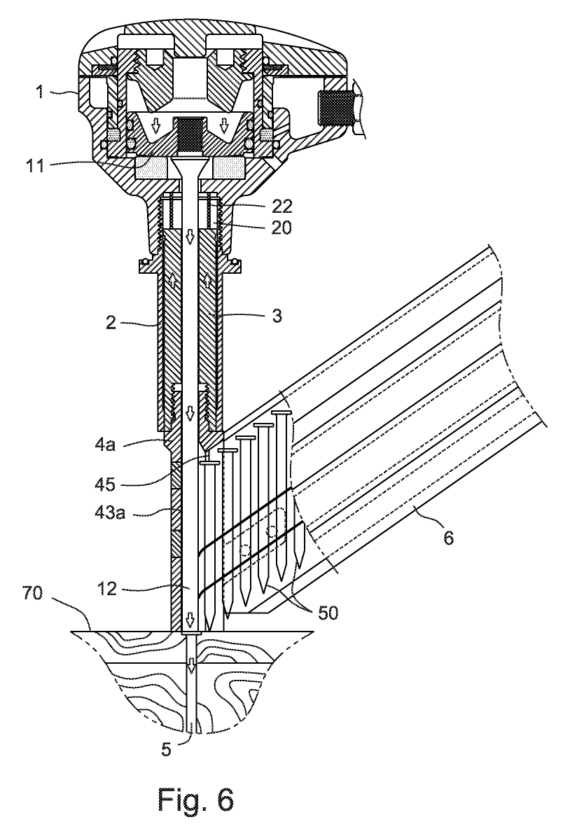

The second guiding sleeve 3 can also engage with a discharge tube of a magazine. Referring to FIGS. 4-6, the discharge tube 4a includes an external thread 46a, which is mated with the internal thread (not labeled) of the second guiding sleeve 3, so as to fix the discharge tube 4a to the joint member 32. The discharge tube 4a has a structure similar to that of the discharge tube, it includes a guiding channel 40a, a chamber 43a, and a magnetic element 44a. However, the discharge tube 4a further includes a sideward passage 45 with an opening, connecting with the chamber 43a. The magazine 6 is engaged with the sideward passage 45, then the plurality of aligned nails 50 can be pressed into the chamber 43a one by one, via the opening of the sideward passage 45. The driving shaft 12 can strike the nails 5 into the work piece 70 in turn.

In summary, the joint member 32 defined at a bottom portion of the second guiding sleeve 3 is able to make the discharge tubes 4, 4a engaging thereto to be disassembled and displace. That is, the joint member 32 can select to engage with a discharge tube 4 containing a single nail or a discharge tube 4a of a magazine 6 having a plurality of nails 50. The user can conveniently displace the different discharge tubes to select the mode of providing nails according to actual requirements, which makes it high in yield efficiency.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

1. A nailing tool, comprising:
a palm nailer including a high pressure induce piston with a plate shape and a driving shaft connecting with the piston, the pneumatic driving shaft being elongated out of the palm nailer via a bottom opening thereof;
a first guiding sleeve fixed to the palm nailer at the bottom opening, the first guiding sleeve comprising a through guiding hole formed therein, at least a first block disposed at a distal end of the guiding hole and a spring entirely disposed in the through guiding hole, the driving shaft being nested by the spring in the first guiding sleeve;
a second guiding sleeve moveably engaged in the first guiding sleeve, including at least a second block to abut and block off the first block, the spring abutting against a top end of the second guiding sleeve and causing the second guiding sleeve to outwardly elongate or inwardly retract relative to the first guiding sleeve;
a joint member defined at a bottom portion of the second guiding sleeve; and
a displaceable discharge tube engaging with the joint member, the discharge tube including a chamber for accommodating a nail, the chamber including a magnetic element for stably holding the nail in the chamber, the driving shaft striking the nail therein.

2. The nailing tool as claimed in claim 1, wherein the joint member includes an internal thread formed on an inner surface of the second guiding sleeve, adjacent a proximal end thereof for engaging with an external thread of the discharge tube.

3. The nailing tool as claimed in claim 1, wherein the discharge tube includes a sideward passage with an opening, which is connected with the chamber accommodating the nail.

4. The nailing tool as claimed in claim 3, wherein the discharge tube is connected with a magazine, and the nails in the magazine are pushed into the chamber via the sideward passage.
